(19) United States
(12) Patent Application Publication
(10) Pub. No.: US 2026/0201619 A1
(43) Pub. Date: Jul. 16, 2026

(54) SYSTEMS AND METHODS FOR SEWING AND UN-WRINKLING FABRICS

(71) Applicant: CENTRE FOR GARMENT PRODUCTION LIMITED, Hong Kong (CN)

(72) Inventors: Kazuhiro KOSUGE, Hong Kong (CN); Fuyuki TOKUDA, Hong Kong (CN)

(73) Assignee: CENTRE FOR GARMENT PRODUCTION LIMITED, Hong Kong (CN)

(21) Appl. No.: 19/103,530

(22) PCT Filed: Sep. 14, 2022
(86) PCT No.: PCT/CN2022/118736

§ 371 Date: Feb. 12, 2025

(51) Int. Cl. D05B 19/16; B25J 9/00; B25J 9/16; B25J 11/00

(52) U.S. Cl. CPC D05B 19/16; B25J 9/0087; B25J 9/1697; B25J 11/005

(57) ABSTRACT

An automatic robotic sewing system including a sewing device; a work surface on which fabric is sewn by the sewing machine; a dual-manipulator robot with force/torque sensors and fabric-handling end-effectors for moving the fabric over the work surface. A vision module is positioned over the work surface and above the robot manipulators. The vision module provides an image of the fabric at least in the area where it is to be sewn; and a controller sequences the sewing device, robot manipulators and vision module to enable seam line determination, seam line tracking and wrinkle removal under visual servo control. As a result, free-form sewing and un-wrinkling of the fabric is achieved.

### CROSS-REFERENCE TO RELATED PATENT APPLICATIONS

This application is a U.S. National Stage Application under 35 U.S.C. § 371 of International Patent Application No. PCT/CN2022/118736, filed Sep. 14, 2022, which is incorporated herein by reference in its entirety. The International Application was published in English on Mar. 21, 2024 as International Publication No. WO 2024/055202 A1.

### FIELD OF THE INVENTION

The present invention relates to the field of garment production and, more particularly to automated sewing systems having a dual-manipulator robot with end-effectors for maneuvering fabric parts to facilitate sewing operations.

### BACKGROUND OF THE INVENTION

In the field of garment production fabric parts or panels are handled and transferred to a sewing workstation for performing intended stitching, binding or hemming processes. In the traditional garment production industry, sewing operations are predominately carried out by human workers in such a way that the pose and shape of fabric parts are controlled by human hands with the aid of a prefabricated fixture or clamp, so that the fabrics can be sewn along a desired seam line. Such operations are labor intensive and the outcomes, including sewing precision, uniformity and speed, are highly dependent on the skills of the operator himself/herself.

Thus, in conventional sewing operations, workers use their own hands to precisely manipulate the fabric part(s) and sew it/them along the desired seam line using a sewing machine in typical garment production processes such as seaming or hemming. Precise sewing requires skillful technique that comes after a considerable period of training and practice, and manual sewing operations are labor-intensive per se, i.e., are not production-efficient and are prone to difficulties brought about by global labor shortages. Some sewing tasks can be automated by machines, but such automatic sewing machines require special clamps and fixtures that need to be custom-designed and fabricated for each shape, size, and material of the fabric parts. The main purpose of these clamps and fixtures is to secure the fabric parts and provide suitable slots or grooves along which the sewing is guided. While such an approach may automate certain sewing tasks without much human intervention, its flexibility is hampered by the fact that the shapes of the clamps and fixtures are all fixed and cannot be adapted to shapes other than those dictated by the clamps. This automation approach is applicable to the high volume production of garment articles having identical construction and style; but in the event of a style change all of the fixtures/clamps have to be replaced, and the machines reconfigured, preventing such an approach from being viable for the production of highly customized garments where the market, particularly the online retail sector, perceives immense potential. Thus, such an implementation is laborious and does not favor the production of customized garments, thus necessitating a new type of production methodology capable of “high variation, low volume” manufacturing at a reasonable cost.

Considering the case of manual sewing, not only do the workers have to manipulate the fabric parts with respect to the sewing machine and closely follow the desired stitching path or seam line, but they also have to ensure that the fabric parts are properly flattened and are free of unwanted folds or wrinkles, especially at the portion to be stitched. Failing this will result in interruptions in the sewing process and/or defective items. As such, the ability to detect folds or wrinkles and to eliminate the same from the fabrics as necessary represents an important function of an automated sewing system that can perform sewing operations in intelligent and versatile ways like human workers do.

Even though some semi-automation systems have become available on the market for automating the sewing of certain classes of fabric components, these systems are still reliant on the use of fixtures/clamps, thereby limiting the flexibility of production towards a broader customization of garment articles. Some of these prior systems use computer vision and robotic arms for manipulating fabric parts during sewing operations. See for example U.S. Pat. No. 10,366,175. However, many require the use of frames or fixtures, which limit the types of garments that can be made with a single setup. They may also require 3D body scans that employ ink fiducial marks on the fabric as part of the computer vision. Some prior art systems are also capable of locating and flattening wrinkles. See U.S. Pat. No. 11,053,618, which uses budgers to (i) transport fabric parts unidirectionally, (ii) rotate the fabric about an axis, or (iii) twist/stretch/bulge the fabric to reduce wrinkles.

### SUMMARY OF THE INVENTION

The present invention is directed to an automated robotic sewing operation using an intelligent system that can perform precise manipulation of fabric materials so as to solve the problems of the prior art, i.e., (1) a wide range of sewing tasks have to be done manually and repetitively while factories are faced with a global shortage of garment workers and (2) mechanical fixtures/clamps, which are necessary for today's sewing systems, need to be designed and manufactured based on each and every different shape and material of the fabric parts.

The conceptual model of the automated robotic sewing system of the present invention has several main features, including (i) a sewing device, (ii) a dual-manipulator robot with force/torque sensors and fabric-handling end-effectors, (iii) a vision module and (iv) sequences that enable seam line determination, seam line tracking and wrinkle removal. This sewing robot system is a universal sewing automation system that does not require any auxiliary clamps and fixtures, which are otherwise essential to conventional automation facilities, to assist with the sewing operations. The present invention can be applied to sewing a fabric part, or multiple fabric parts, along a preset seam line of variable geometries ranging from a substantially straight line to a complex line that features a wide range of curvatures.

The seam line to be sewn can be a visible line or an invisible line. In the case of a visible line, it can be a line marked/printed directly on the fabric material or projected as an image onto the fabric material. In the case of an invisible line, it can be a virtual line offset by a distance (i.e. margin) from a physical edge or boundary of the subject fabric material, or any other free-form line as determined by its corresponding computer aided design (CAD) model.

With the robot manipulator-based system of the present invention, once a fabric part is brought under the vision of the robotic system, the system can automatically maneuver the fabric part and perform sewing along a desired seam line using the sewing device. The seam line can either be a visible line marked on the surface of the fabric part, or a virtual line determined by computerized data, such as a CAD model. By utilizing a dual-manipulator configuration, the robot can affect coordinated motions of both robotic arms and can function like the upper extremities of a human worker in the course of fabric manipulation. The computer vision of the system can precisely track the seam line and analyze images of the fabric part being processed for surface irregularities. When a wrinkle or fold is identified, the robot will carry out corrective actions to straighten out the fabric. Automatic sewing using the present invention can effectively replace manual operations and allow customized production of garments on the fly without the use of any fixture or the like.

With the present invention computer vision guidance and wrinkle detection can be achieved with only 2D video from a monochrome camera providing gray scale images.

### BRIEF DESCRIPTION OF THE DRAWINGS

The foregoing and other objects and advantages of the present invention will become more apparent when considered in connection with the following detailed description and appended drawings in which like designations denote like elements in the various views, and wherein:

FIG. 1 is an exemplary setup of a robotic sewing and un-wrinkling system according to the present invention;

FIG. 2 is a structural diagram of the robotic sewing and un-wrinkling system according to the present invention;

FIG. 3 is an example of a Base Sequence of the robotic sewing and un-wrinkling system according to the present invention;

FIG. 4 is an example of a Seam Line Determination sequence according to the present invention;

FIG. 5 is an exemplary setup for automated sewing under visual seam line tracking control according to the present invention;

FIG. 6 is an example of a Visual Seam Line Tracking Control sequence according to the present invention;

FIGS. 7A-7C are illustrations of fabric parts sewn by the developed system of the present invention, where FIG. 7A is a straight line, FIG. 7B is an arc line and FIG. 7C is a wavy line;

FIG. 8 is an exemplary setup for automated un-wrinkling under visual wrinkle-free control according to the present invention;

FIG. 9 is an example of a Visual Wrinkle-Free Control sequence according to the present invention; and

FIGS. 10A-10B illustrate the elimination of wrinkles on a fabric by the robotic system using the visual wrinkle-free control according to the present invention wherein FIG. 10A shows the initial condition of the fabric with wrinkles and FIG. 10B shows the final condition with the wrinkles removed.

### DETAILED DESCRIPTION OF THE INVENTION

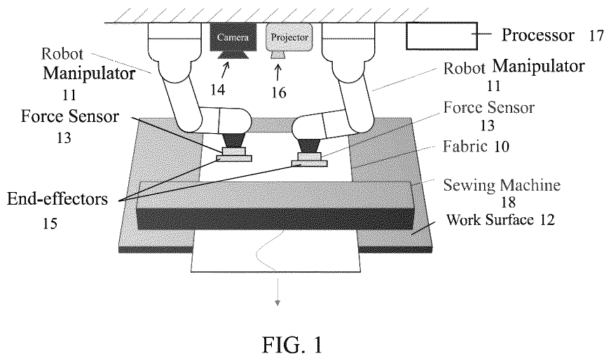

FIG. 1 illustrates an embodiment of the present invention for automated free form sewing and un-wrinkling under visual servo control. The system includes two robot manipulators 11 (i.e., a dual-manipulator) each equipped with a force/torque sensor 13 and an end-effector 15 for moving fabric materials 10 on a working surface 12. The system further comprises a camera (vision sensor) 14, a projector (pattern generator) 16, and a sewing machine 18. The operation of the system is controlled by a controller or processor 17, e.g., a computer as further described below.

The end-effectors 15, which are used for moving fabric materials 10, may come with different designs and mechanisms depending on the complexity of the tasks. For instances, they can be grippers having multiple jaws, specialty end-effectors for free-form folding and/or pick-and-place operations (such as the F-FOLD end-effector disclosed in PCT/CN2022/090459), vacuum heads, or pads made of soft/elastic materials. In this embodiment of FIG. 1, a simple flexible foam-pad or sponge, which contains no internal actuators, is used as the end-effector for maneuvering the fabric.

When the operation begins, the fabric is depressed by the two end-effectors whose movements are controlled by the robot manipulators. The force/torque sensor between the robot manipulator and the end-effector senses the depression force and assists with the regulation of the force and levelling of the end-effectors relative to the work surface, so that the end-effectors do not slip when the fabric is held down and translated on the surface. It should be noted that that the present system is capable of operating with a single robot manipulator, although a dual-manipulator robot, as depicted in FIG. 1, is a preferred configuration by virtue of the coordinated movement of robotic arms which gives rise to enhanced efficiency in carrying out the same task, e.g., smoothing or flattening the fabric.

The sewing device or machine 18 is an integral part of the present system. The sewing machine utilized in the present embodiment is a programmable sewing machine whose motion can be synchronized with the robot and collectively controlled by the system's central controller. Nevertheless, the use of a programmable sewing machine is not essential and most off-the-shelf sewing machines can be configured to work with the present robotic system. Contemporary sewing machines generally feature a sewing needle, a presser foot and feed dogs. The function of the presser foot is to apply pressure on top of the fabric so as to press it against the feed dogs, whereas the purpose of the feed dogs is to grip the bottom portion of the fabric and help the fabric advance through the sewing machine.

Since the movement of the fabric is fully controlled by the robot in the present system, the presser foot and feed dogs of the sewing machine are not necessary and may simply be disengaged or removed. For example, most contemporary sewing machines allow the presser foot to be raised and feed dogs lowered to disable the feeding function. By doing so, these sewing machines can be integrated with the present robotic system to perform automated sewing on a work surface roughly at the same level as the needle plate of the sewing machine. As a more preferred configuration, the sewing device with the present invention is a programmable sewing machine where the system's central processor or controller 17 can independently control the speed of the sewing needle. For example, the processor can be a computer equipped with a x86-based multi-core processor, memory, a graphics processing unit, I/O ports and network interfaces. With a programmable sewing machine, a major advantage is that the needle speed can be varied in response to any change in the translational speed of the end-effectors which feed the fabric, thereby ensuring uniform stitching pitch along the seam line. Without a real-time control of the needle speed, as in the case of non-programmable sewing machine, the feeding speed of the fabric would have to be kept constant by the robot.

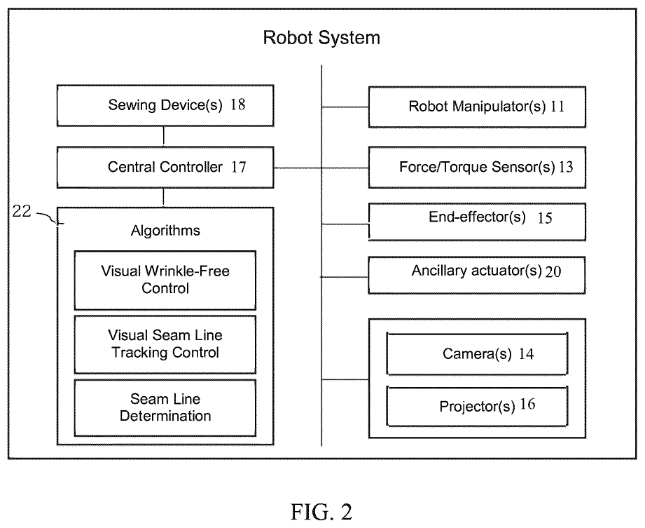

Positioned above the end-effectors 15 is the vision module which comprises a camera unit 14 and a projector unit 16 having an illumination source. The camera serves to perform image acquisition whereas the projector gives rise to an illuminated pattern over a surface area that covers the subject fabric in full or in part. An exemplary architecture of the robot system is given in FIG. 2. The system may contain one or more of each type of system component as shown, including robot manipulator 11, force/torque sensor 13, end-effector 15, sewing device (e.g., a sewing machine) 18, camera 14, projector 16, as well as ancillary actuator 20, which can be deployed to aid the handling of the fabric part or toggle a switch/button where the activation of additional machine(s) is needed. The central controller 17 connects the system components and implements multiple algorithms 22, including “seam line determination”, “visual seam line tracking control” and “visual wrinkle-free control.” Please note that the term “seam line” in the present context also carries a meaning equivalent to a “sewing path” or “stitching path” and it is not limited to the process of joining together multiple pieces of fabric materials. It can also be applied in an embroidery process where only a single piece of fabric is processed.

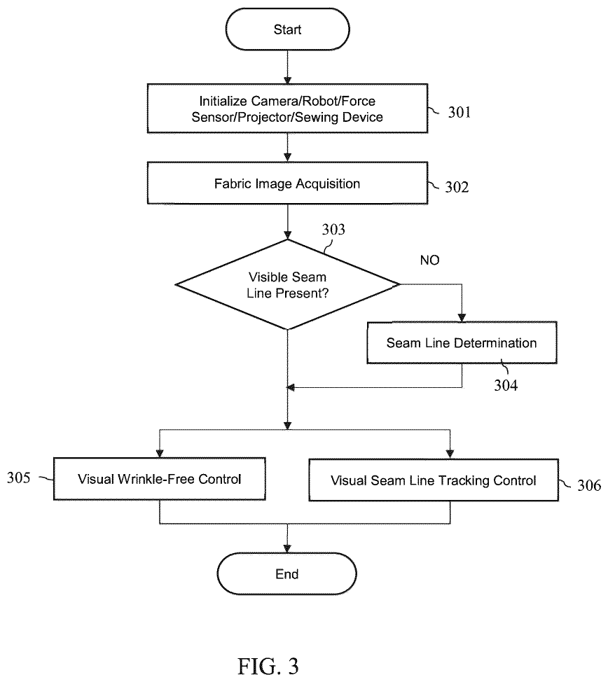

The base sequence of robotic sewing and un-wrinkling workflow is exemplified in FIG. 3. Upon initializing the system components (Step 301), the central controller 17 analyses an image of the subject fabric 10 captured or acquired by the camera 14 (Step 302) and verifies whether any visible seam line is present on the fabric (Step 303). If not, the system executes the seam line determination sequence (Step 304) and works out the path of the seam line with reference to a corresponding CAD model (or numerical data) against the fabric's current orientation and position. Once the seam line is identified, the system proceeds to carry out automated sewing along such seam line under the visual seam line tracking control (Step 306) and visual wrinkle-free control (Step 305) until the task is completed (End). The Key points of the method of the present invention are (1) independent control of the internal and external forces acting on the fabric using force sensors, (2) a depth image (3D) is unnecessary, (3) only grayscale imaging is necessary, (4) a feedback control scheme is used for both wrinkle elimination and seam line tracking.

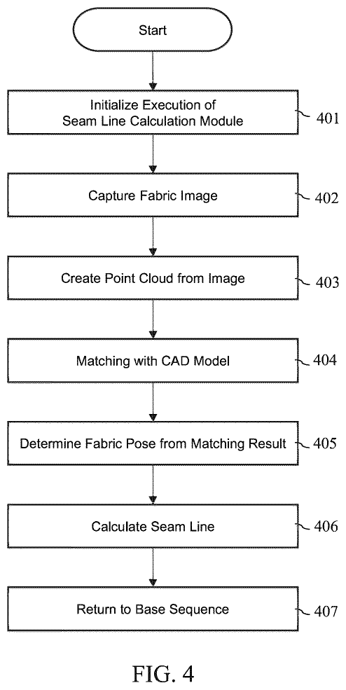

In the case where a visible seam line, such as a hand-marked, printed or projected line, is absent, the Seam Line Determination sequence enables the computation of a desired seam line on the subject fabric material. FIG. 4 illustrates an example of such a sequence which begins with initialization and acquisition of fabric's image (Steps 401 and 402). Data points in space, such as a point cloud, are created from the image (Step 403) and are compared with those of the corresponding CAD model of the subject fabric part (Step 404). In doing so, the actual position and orientation of the fabric part (fabric pose) are determined (Step 405) and the virtual seam line, i.e., the sewing path, can be calculated with respect to the fabric part (Step 406). Coordinate transformation is performed when a change in the pose of the fabric is detected, and the seam line remains at the same location relative to the fabric part. When a seam has been sewn, the program or algorithm returns to the base sequence (Step 407). As opposed to prior art U.S. Pat. No. 11,053,618 B2, the present sequence does not require the collection of depth information or coloured (RBG) images, leading to more relaxed requirements on the camera used with the present invention.

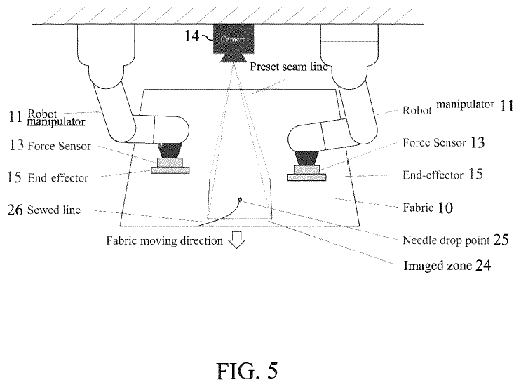

A setup for an automated sewing operation under the visual seam line tracking control is illustrated in FIG. 5. The visual seam line tracking control serves to visualize the fabric part and control the motions of the robotic system and the actuators of the sewing device, so that the fabric is sewn steadily along a pre-set seam line. The sensing devices involved in this control method include the camera 14 as well as the force/torque sensor connected to each end-effector 15. The function of the force/torque sensors 13 is to monitor the forces excreted by the end-effectors on (i) the work surface in the normal direction and (ii) the fabric material along the plane parallel to the work surface, i.e., lateral directions. These forces are regulated by closed-loop servo control, which adjusts the torque of each joint of the robot manipulators 11 to attain the desired force output.

During operation, the image captured by the camera 14 is analysed in real-time to calculate the trajectories of each end-effector and the needle of the sewing device. The zone imaged by the camera 24 should cover the needle drop point 25 and at least a portion of the fabric material. Here the camera 14 can be a digital camera having a monochrome (e.g., grayscale) or colour image sensor, regardless of depth-sensing capability. The pre-set seam line can be a visible line on the fabric, or it can be an invisible line as determined by the Seam Line Determination sequence. With reference to the positional data corresponding to the pre-set seam line, the system performs a calculation of the waypoint where the needle drop point 25 coincides with the seam line. In doing so, the angular velocities of the joints are determined and control of the motions of the robot manipulators and that of the sewing needle are simultaneously implemented until the sewing task of sewing along the sewed line 26 is completed.

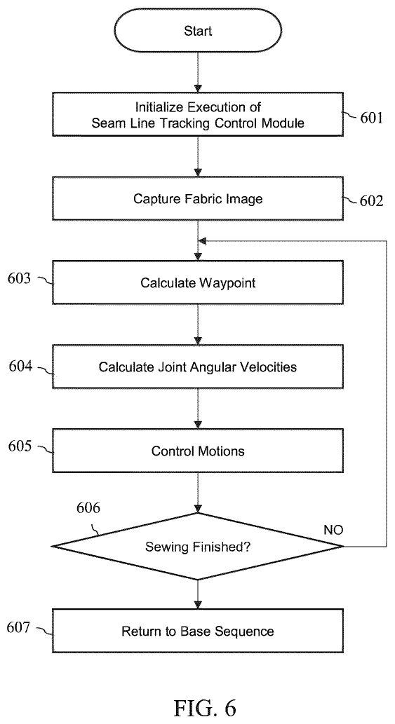

As another embodiment, the present system is operable with a regular sewing machine where the system's controller cannot program its needle speed. In this case, the motion control applies to the joints of the robotic manipulator arms only. The feedback control scheme is capable of adapting to physical disturbance or errors associated with the calculated joint velocities so that the seam line relative to the needle drop point can be continuously tracked. An example a sequence of the visual seam line tracking control is illustrated in FIG. 6.

In FIG. 6, the sequence begins with initialization and acquisition (capture) of fabric's image (Steps 601 and 602). A calculation of the waypoint where the needle drop point 25 coincides with the seam line is performed at Step 603. Then the angular velocities of the manipulator joints are calculated at step 604. Based on the waypoint and joint angular velocities calculations, motion controls are determined at (Step 605). A determination is made at Step 606 as to whether the sewing task has been completed. If it has not, the sequence returns to the beginning at Step 603. If it has been completed the program or algorithm returns to the base sequence (Step 607).

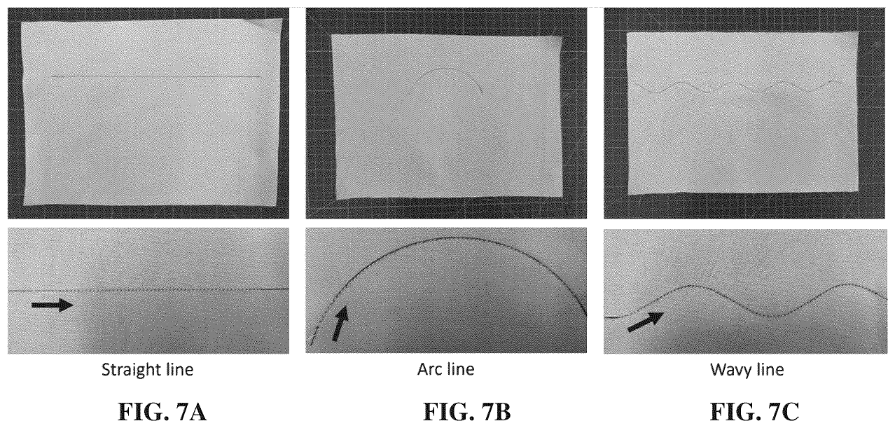

FIG. 7 shows a series of sample fabric parts (about 20 cm×30 cm in size) sewn along pre-set seam lines under the visual seam line tracking control. In this illustration, predetermined seam lines are printed on the fabric parts for illustration purpose. The result indicates that the sewing system is capable of sewing a fabric part automatically along different pre-set geometries including a straight line (left) (FIG. 7A), an arc line (middle) (FIG. 7B) and a wavy line (right) (FIG. 7C), with high positional accuracy.

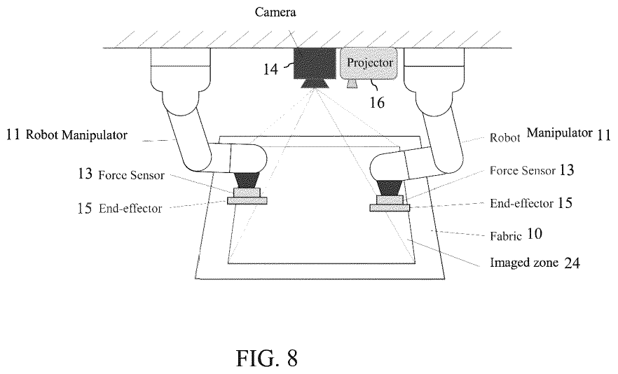

An exemplary setup for visual wrinkle-free control, which enables automatic removal of wrinkles on fabric, is illustrated in FIG. 8. To ensure a smooth sewing process, precautions ought to be taken so that the fabric parts are free of folds or wrinkles before they are sewn. Therefore, in conventional manual sewing operations stretching or pulling of fabric is frequently done by the human operator to flatten out the fabric before feeding it through the sewing machine. The visual wrinkle-free control of the present invention is an algorithm that allows the end-effectors 15 to apply tension on the fabric along suitable directions so as to undo folds or wrinkles. The sensing devices involved in this control module include the camera 14 and the force/torque sensor 13 connected to each end-effector 15. Here the camera can be a digital camera having a RGB (colour) or a monochrome (grayscale) image sensor regardless of depth sensing capability. The zone imaged by the camera (imaged zone 24) should cover at least a portion of the subject fabric 10 over which wrinkles are detected. The projector 16 can be any device capable of projecting an illuminated pattern onto a surface. The force/torque sensors 13 serve to monitor the forces excreted by the end-effectors on the work surface in the normal direction and on the fabric material along the plane parallel to the work surface. In particular, force data are used as an input to the visual servo control algorithm, which play a significant role in improving the stability, positional accuracy and convergence domain of the control system.

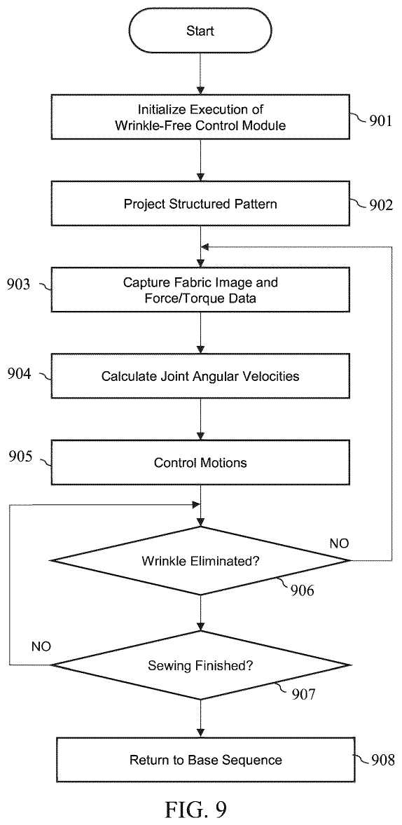

FIG. 9 shows a sequence which exemplifies the Visual Wrinkle-Free Control method. It begins with initialization of execution of the module in Step 901. Since bumps and dips of the fabric are difficult to recognized with a single image without triangulation, a pattern, preferably a structured pattern, is further projected onto the surface of the subject fabric in Step 902 so that additional contrasts are created and captured by the camera (Step 903). Image data captured by the camera 14 are processed in real-time and analysed for any discrepancy from an otherwise flat surface. To enhance the vision, the camera is preferably positioned in such a way that its optical axis is inclined at an angle (preferably 45±20 degrees) from the surface normal of the subject fabric. Wrinkles are determined by analysing the visual features from the images without using three-dimensional topographic data of the fabric, which would require distance or depth measurement (as in prior art U.S. Pat. No. 11,053,618 B2). Data from the force/torque sensors are also captured in Step 903, which measure the various forces experienced by the end-effectors.

When the sequence determines that a wrinkle or multiple wrinkles is/are present on the fabric, joint angular velocities of each robot manipulator are calculated (Step 904) and the robot is controlled to maneuver the fabric following a visual servo approach to flatten out the wrinkle(s) in Step 905. The flattening process comprises pulling or stretching actions. On implementing these actions, forces are measured to avoid excessive stress on the fabric that may cause unintended damages. Moreover, the data collected from the force/torque sensors are related to the tension developed inside the fabric and used as a feedback signal. In the case of a rapid change in the force measured along the direction of stretching, e.g., when the fabric is fully stretched, the stretching motion will stop. The above processes repeat until the system in Step 906 detects no more wrinkle on the fabric. The sequence will then check if the sewing is completed in Step 907 and return to the base sequence if done (Step 908). If not done, the sequence returns to the beginning of Step 906.

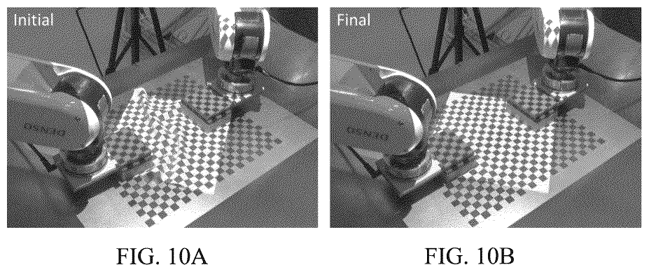

FIG. 10 shows the process where a fabric part (about 25 cm×25 cm in size) is flattened by the robot under the visual wrinkle-free control. In this demonstration, the camera captured the image of the fabric part which was illuminated with a checkerboard pattern by the projector. The checkerboard pattern serves as an example of the structured pattern. Other patterns are feasible provided that the computer vision model has been trained with those patterns. The force sensors attached to the end-effectors provide information as to whether the fabric has been sufficiently stretched. The result demonstrates that the wrinkles once existed on the fabric parts (left) were stretched out (right) by coordinated movements of the end-effectors.

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. An automatic robotic sewing system, comprising:
a sewing machine;
a work surface on which fabric is sewn by the sewing machine;
at least one robot manipulator arm each with at least one force/torque sensor and at least one fabric-handling end-effector for moving the fabric over the work surface;
a vision module positioned over the work surface and above the robot manipulator, said vision module providing an image of the fabric at least in the area where it is to be sewn; and
a controller that sequences the sewing machine, robot manipulator and vision module to enable seam line determination, seam line tracking and wrinkle removal under visual servo control, whereby free form sewing and un-wrinkling of the fabric is achieved.

2. The automatic robotic sewing system of claim 1, wherein the end-effectors are at least one of grippers having multiple jaws, specialty end-effectors for free-form folding or for pick-and-place, vacuum heads, or pads made of soft/elastic materials.

3. The automatic robotic sewing system of claim 1, wherein the end-effectors are a simple flexible foam-pad or sponge, which contains no internal actuators.

4. The automatic robotic sewing system of claim 1, wherein the vision module includes a camera that serves to perform image acquisition and a projector having an illumination source to provide an illuminated pattern over a surface area that covers the fabric both being part of the visual servo control.

5. The automatic robotic sewing system of claim 4, wherein the camera is a monochromatic camera that produces greyscale images.

6. The automatic robotic sewing system of claim 1, further including an ancillary actuator, which can be deployed to aid the handling of the fabric or to toggle a switch/button where the activation of additional machine(s) is needed.

7. The automatic robotic sewing system of claim 1 wherein the processor connects the system components and implements multiple control algorithms.

8. The automatic robotic sewing system of claim 7 wherein the base algorithm comprises the steps of:
analysing an image of the fabric captured by the camera;
verifying whether any visible seam line is present on the fabric, and if not, executing a seam line determination sequence to determine the path of a seam line with reference to a corresponding model against the fabric's current orientation and position; and
if the seam line is identified, carrying out automated sewing along such seam line under visual seam line tracking control sequence and visual wrinkle-free control sequence until the task is completed.

9. The automatic robotic sewing system of claim 8 wherein the seam line is one of hand-marked, printed or projected from a projector of the vision module and the seam line determination sequence comprises the steps of:
acquiring an image of the fabric;
creating a set of data points in space from the image;
comparing the data points with those of a corresponding model of the fabric while determining the actual position and orientation of the fabric;
calculating a virtual seam line or sewing path with respect to the fabric;
performing a coordinate transformation when a change in the position and orientation of the fabric is detected and the seam line remains at the same location relative to the fabric; and
sewing the fabric.

10. The automatic robotic sewing system of claim 8 wherein the visual seam line tracking control sequence comprises the steps of:
acquiring an image of the fabric;
calculating of a waypoint where a needle drop point of the sewing machine coincides with the seam line;
calculating angular velocities of joints of the robot manipulator;
based on the waypoint and joint angular velocities calculations, determining motion controls; and
determining whether the sewing task has been completed.

11. The automatic robotic sewing system of claim 8 wherein one of the algorithms is visual wrinkle-free control sequence, comprising the steps of:
calculating angular velocities of joints of the robot manipulator when the sequence determines that a wrinkle is present on the fabric;
controlling the robot manipulator to maneuver the fabric following a visual servo approach to flatten out the wrinkle by pulling or stretching actions;
measuring the forces of the pulling or stretching actions to avoid excessive stress on the fabric that may cause damages; and
checking to see if the wrinkle is still present and repeating the steps until it is not.

12. The automatic robotic sewing system of claim 11 wherein during the measuring step, data collected from the force/torque sensors are related to the tension developed inside the fabric and are used as a feedback signal, so that in the case of a rapid change in the force measured along the direction of stretching, e.g., when the fabric is fully stretched, the stretching motion will stop.

13. The automatic robotic sewing system of claim 1 further including a second robot manipulator arm with a force/torque sensor and a fabric-handling end-effector for moving the fabric over the work surface.

14. The automatic robotic sewing system of claim 1 wherein the sewing machine has at least one motor that preferably actuates a sewing needle, which can be controlled by the processor for regulating the pitch of stitches.

15. A method for automatically sewing fabric, comprising the steps of:
analysing an image of the fabric captured by a camera positioned over a work surface on which at least one piece of fabric is located;
verifying whether any visible seam line is present on the fabric, if so executing a seam line determination sequence and if not working out the path of the seam line with reference to a corresponding model against the fabric's current orientation and position; and
once the seam line is identified, carrying out automated sewing along such seam line under the visual seam line tracking control sequence and visual wrinkle-free control sequence until the task is completed.

16. The method for automatically sewing fabric according to claim 15 wherein the seam line determination sequence comprises the steps of:
creating a set of data points in space from the image;
comparing the data points with those of a corresponding model of the fabric while determining the actual position and orientation of the fabric
calculating a virtual seam line or sewing path with respect to the fabric; and
performing a coordinate transformation when a change in the position and orientation of the fabric is detected and the seam line remains at the same location relative to the fabric.

17. The method for automatically sewing fabric according to claim 15 wherein the visual seam line tracking control sequence comprises the steps of:
calculating a waypoint where a needle drop point of the sewing machine coincides with the seam line;
calculating angular velocities of joints of the robot manipulator;
based on the waypoint and joint angular velocities calculations, determining motion controls; and
determining whether the sewing task has been completed.

18. The method for automatically sewing fabric according to claim 15 wherein the visual wrinkle-free control sequence comprises the steps of:
calculating angular velocities of joints of the robot manipulator when the sequence determines that a wrinkle is present on the fabric;
controlling the robot manipulator to maneuver the fabric following a visual servo approach to flatten out the wrinkle by pulling or stretching actions;
measuring the forces of the pulling or stretching actions to avoid excessively stress on the fabric that may cause damages; and
checking to see if the wrinkle is still present and repeating the steps until it is not.
